(19) United States
(12) Patent Application Publication
(10) Pub. No.: US 2015/0251207 A1
(43) Pub. Date: Sep. 10, 2015

(54) Adhesive applying machine

(71) Applicant: Yu-Cheng Huang, Changhua (TW)

(72) Inventor: Yu-Cheng Huang, Changhua (TW)

(21) Appl. No.: 14/720,957

(22) Filed: May 25, 2015

(51) Int. Cl. B05C 1/08; B05C 11/11

(52) U.S. Cl. CPC B05C 1/0813; B05C 1/0821; B05C 11/11

(57) ABSTRACT

An adhesive applying machine includes a housing; an endless, elastic, continuously flexible transfer belt including a plurality of rolls; an adhesive applying device including a tank for storing molten adhesive, an adhesive roller partially disposed in the tank, and a drive roller below the adhesive roller and being in rotational contact with the adhesive roller; and a driven roller below the drive roller and configured to be rotated by the drive roller. In an adhesive applying operation the driver roller activates to rotate the adhesive roller which in turn brings the adhesive out of the tank to apply on the drive roller, and the driven roller rotates to move one workpiece through a joining line of the driver roller and the driven roller, thereby adhere the adhesive on the workpiece.

### BACKGROUND OF THE INVENTION

1. Field of the Invention

The invention relates to adhesive applying machine and more particularly to a conveyor belt based adhesive applying machine.

2. Description of Related Art

Adhesive applying machines are well known in the art. For example, a conventional adhesive applying machine comprises a tank for storing adhesive, a roller adapted to rotate in the tank, a driver connected to the roller for selectively rotating the roller, and a heater for heating adhesive in the tank.

While the machine enjoys its success in the market, continuing improvements in the exploitation of adhesive applying machine are constantly sought.

### SUMMARY OF THE INVENTION

It is therefore one object of the invention to provide an adhesive applying machine comprising a housing; an endless, elastic, continuously flexible transfer belt disposed externally of the housing and including a plurality of rolls; an adhesive applying device disposed on the housing and including a tank for storing molten adhesive, an adhesive roller partially disposed in the tank and extending out of the tank, and a drive roller disposed below the adhesive roller and being in rotational contact with the adhesive roller; and a driven roller disposed below the drive roller and configured to be rotated by the drive roller; wherein in an adhesive applying operation the driver roller activates to rotate the adhesive roller which in turn brings the adhesive out of the tank to apply on the drive roller, and the driven roller rotates to move one of a plurality of workpieces through a joining line of the driver roller and the driven roller, thereby adhere the adhesive on the workpiece.

The above and other objects, features and advantages of the invention will become apparent from the following detailed description taken with the accompanying drawings.

### BRIEF DESCRIPTION OF THE DRAWINGS

FIG. 1 is a perspective view of an adhesive applying machine according to a first preferred embodiment of the invention;

FIG. 2 is a side elevation of the adhesive applying machine;

FIG. 3 schematically depicts a conveyor system incorporating two pairs of adhesive applying machines;

FIG. 4 schematically depicts the conveyor system for applying adhesive to soles;

FIG. 5 schematically depicts a conveyor system incorporating four pairs of adhesive applying machines;

FIG. 6 is a side elevation of an adhesive applying machine according to a second preferred embodiment of the invention; and

FIG. 7 is a side elevation of an adhesive applying machine according to a third preferred embodiment of the invention.

### DETAILED DESCRIPTION OF THE INVENTION

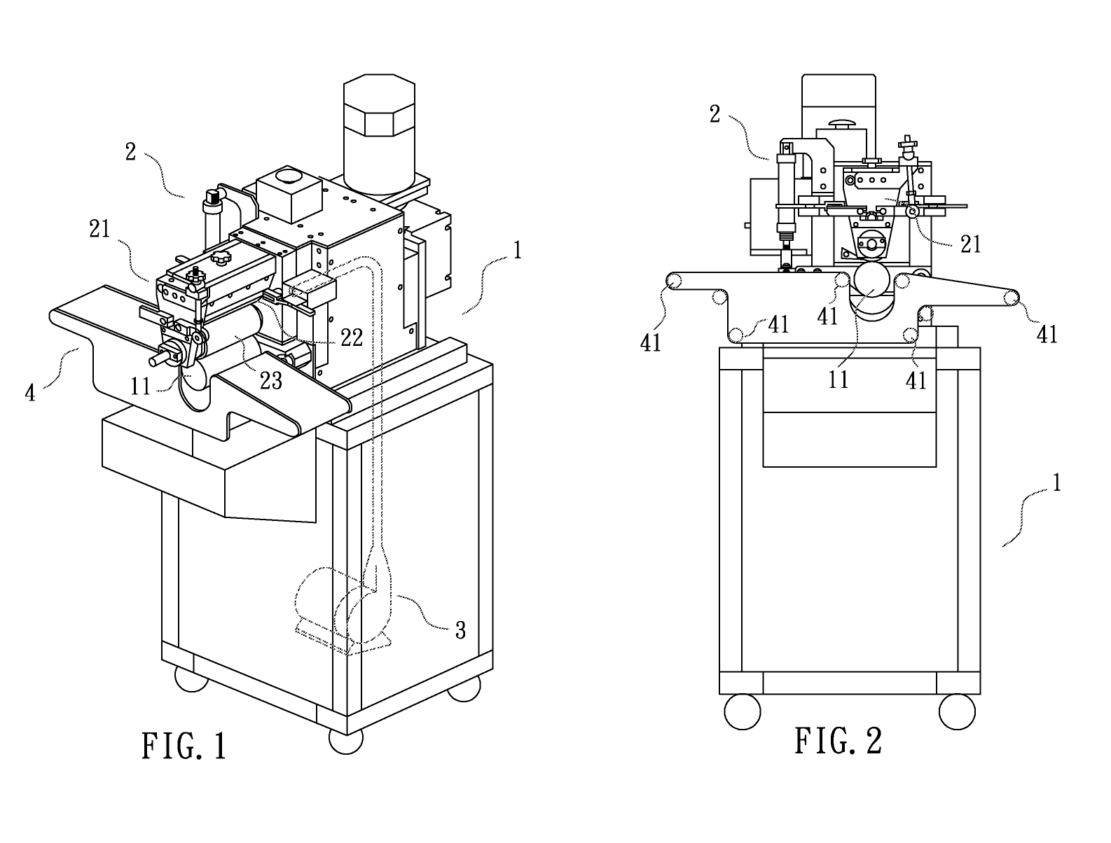

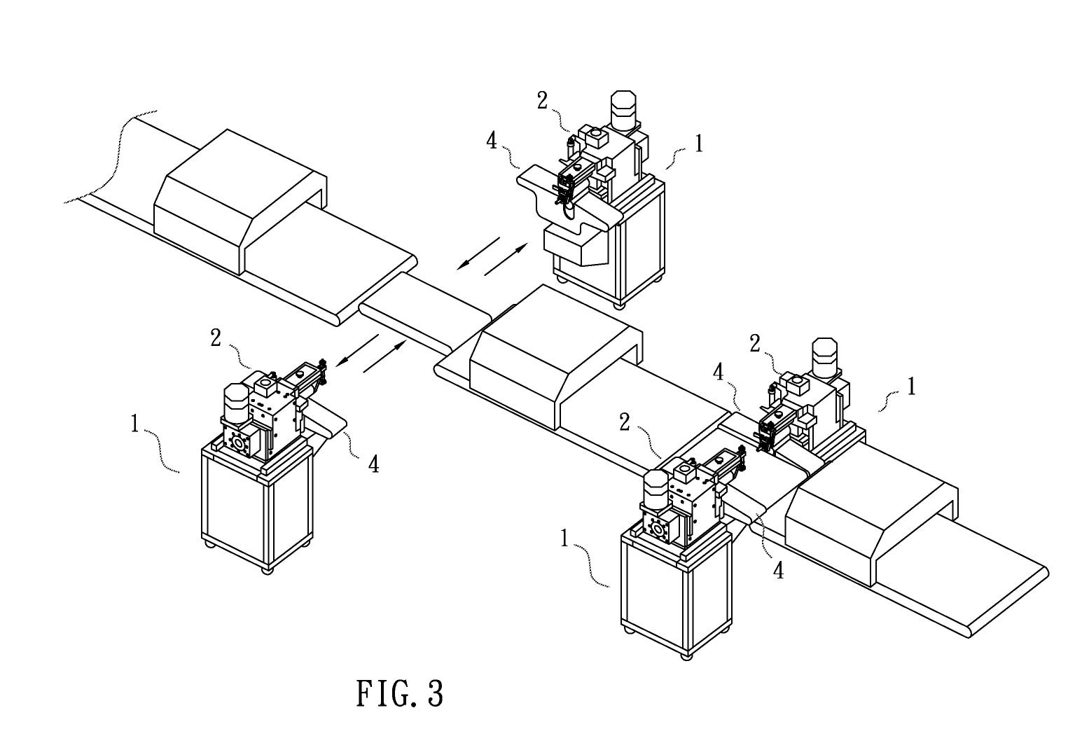

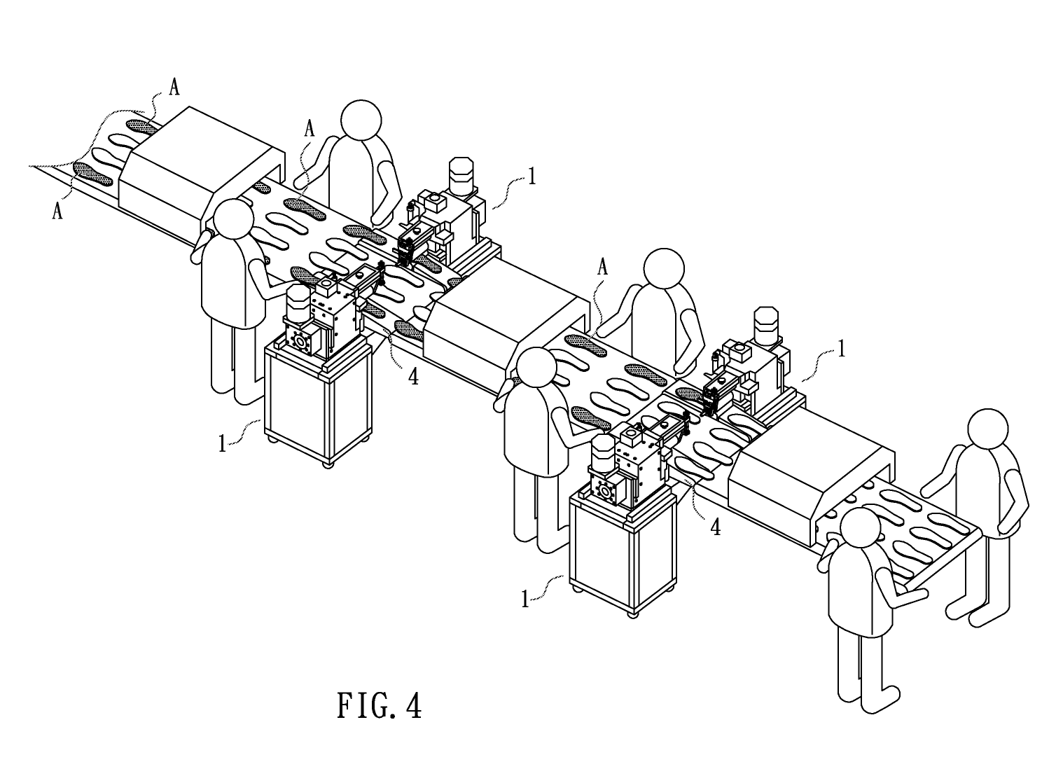

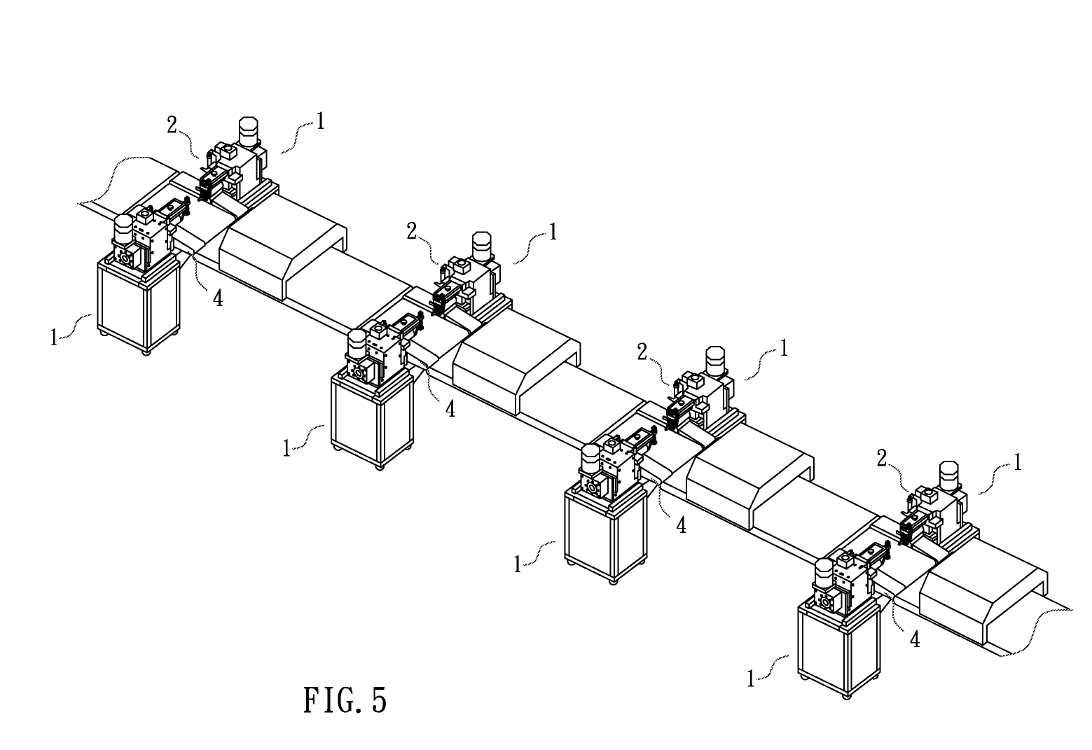

Referring to FIGS. 1 to 5, an adhesive applying machine in accordance with a first preferred embodiment of the invention comprises the following components as discussed in detail below.

A housing 1, a blower 3 in the housing 1 for cooling and ventilating purposes, an adhesive applying device 2 on the housing 1, and a motor driven external transfer belt 4 are provided. The adhesive applying device 2 includes a tank 21 for storing molten adhesive, an adhesive roller 22 partially disposed in the tank 21 and extending out of an outlet of the tank 21, and a drive roller 23 below the adhesive roller 22 and being in rotational contact with the adhesive roller 22. A driven roller 11 is disposed below the drive roller 23 and can be driven by the drive roller 23. The transfer belt 4 is an endless, elastic, continuously flexible transfer belt and includes a plurality of rolls 41 arranged in a loop.

In an adhesive applying operation, the driver roller 23 activates to rotate the adhesive roller 22 which in turn brings the adhesive out of the tank 21 to apply on an outer surface of the drive roller 23. And in turn, the rotating drive roller 23 drives the driven roller 11 to move one of a plurality of workpieces A through a joining line of the driver roller 23 and the driven roller 11, thereby adhere the adhesive on a top surface of the workpiece A.

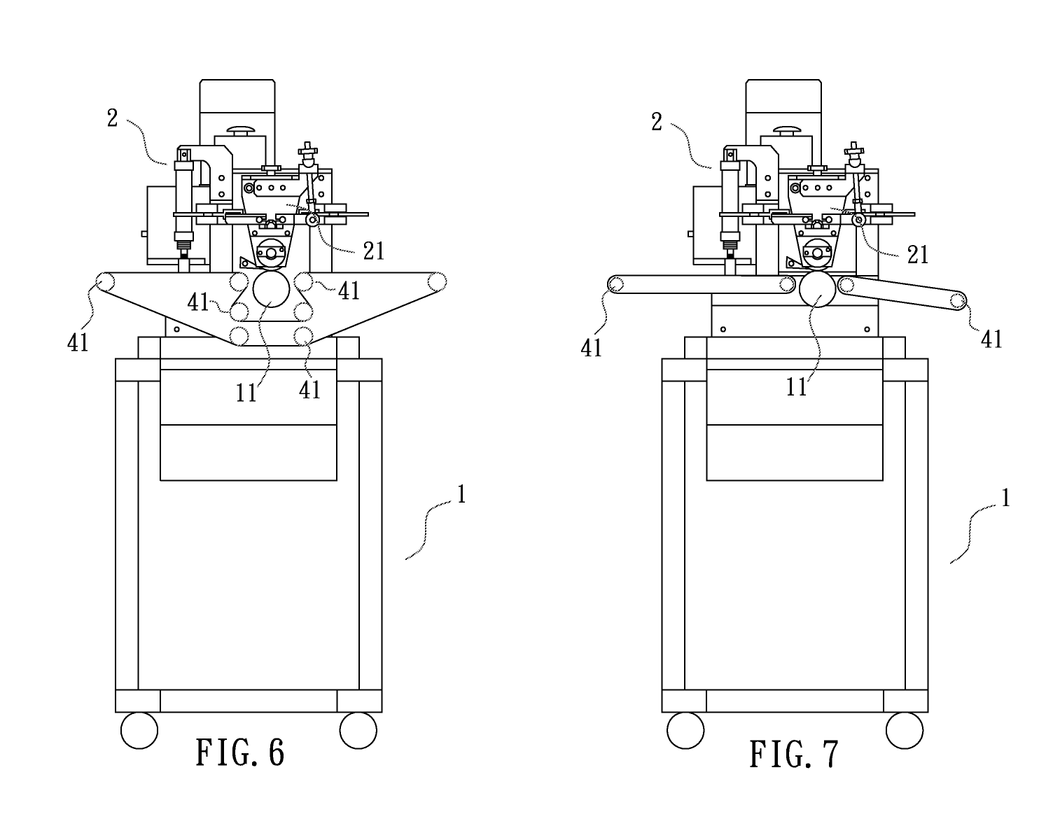

Referring to FIG. 6, an adhesive applying machine in accordance with a second preferred embodiment of the invention is shown. The characteristics of the second preferred embodiment are substantially the same as that of the first preferred embodiment except the following: The rolls 41 are arranged in a loop different from that of the first preferred embodiment.

Referring to FIG. 7, an adhesive applying machine in accordance with a third preferred embodiment of the invention is shown. The characteristics of the third preferred embodiment are substantially the same as that of the second preferred embodiment except the following: The rolls 41 are arranged in two separate loops different from that of the first or second preferred embodiment.

While the invention has been described in terms of preferred embodiments, those skilled in the art will recognize that the invention can be practiced with modifications within the spirit and scope of the appended claims.

What is claimed is:

1. An adhesive applying machine comprising:
a housing;
an endless, elastic, continuously flexible transfer belt disposed externally of the housing and including a plurality of rolls;
an adhesive applying device disposed on the housing and including a tank for storing molten adhesive, an adhesive roller partially disposed in the tank and extending out of the tank, and a drive roller disposed below the adhesive roller and being in rotational contact with the adhesive roller; and
a driven roller disposed below the drive roller and configured to be rotated by the drive roller;
wherein in an adhesive applying operation the driver roller activates to rotate the adhesive roller which in turn brings the adhesive out of the tank to apply on the drive roller, and the driven roller rotates to move one of the workpieces through a joining line of the driver roller and the driven roller, thereby adhere the adhesive on the workpiece.
